(19) United States
(12) Patent Application Publication
(10) Pub. No.: US 2014/0127499 A1
(43) Pub. Date: May 8, 2014

(54) Two Part Primer Composition

(71) Applicant: ASHLAND LICENSING AND INTELLECTUAL PROPERTY LLC, Dublin, OH (US)

(72) Inventors: Dennis Jay Oscar, West Bend, WI (US); Charles J. Wasserman, Waukesha, WI (US); Christopher Zoky, Westerville, OH (US)

(73) Assignee: Ashland Licensing and Intellectual Property LLC, Dublin, OH (US)

(21) Appl. No.: 13/667,061

(22) Filed: Nov. 2, 2012

(51) Int. Cl. B32B 15/082; C09D 133/02; C09D 131/04

(52) U.S. Cl. CPC B32B 15/082; C09D 131/04; C09D 133/02
USPC 428/337; 428/355 EP; 428/354; 428/416; 524/524; 523/122; 427/386; 156/310; 156/314

(57) ABSTRACT

Two part compositions comprising Part A having vinyl acetate ethylene copolymer, acrylic tackifying resin and polyethylene imine, and Part B having an epoxy material curing agent. The two part compositions can be applied to make coated substrates and laminated structures.

### BACKGROUND OF THE INVENTION

1. Field of the Invention

Coating compositions comprising vinyl acetate ethylene copolymers, acrylic tackifying resins, and crosslinking agent. The coating compositions are applied to substrates using typical graphic arts application methods. The compositions provide for water, humidity and heat resistance and also improve the adhesion of adhesives and metallization.

2. The Related Art

Flexible packaging is widely used for food, non-food, and pharmaceutical applications. Flexible packaging uses a wide range of different types of materials including various types of plastic films, paper, and aluminum foil. The plastic films include various types of polyolefins, polyesters, and polyamides. The films may be various combinations of homopolymers, copolymers, and polymer blends. The films may be a single layer or may be coextruded, or laminated to form multiple layers. The films are also commonly coated, metallized, or otherwise treated to enhance the performance of the resulting package. Packaging materials are selected based on a variety of factors including desired barrier properties, appearance, cost, feel, printability, sealing properties, easy open features, and reclosing features.

Packaging materials can be chosen to achieve particular performance depending on the use of the material and the contents of the packaging. For example, when the packaged item is sensitive to oxygen and/or humidity the film material is chosen to provide a barrier against the ingress of oxygen, water vapor and other gases. Film materials may be selected for heat resistance. Packaging items, particularly certain foods, in a gaseous atmosphere within the packaging material is often desired and thus, packaging materials can be selected for low permeability to gas to create controlled atmosphere packaging or modified atmosphere packaging.

Thin layers of a metal such as aluminum and metallized film are used to improve the barrier of the film to oxygen, other gases, and humidity. Metallized films can be further laminated to a heat sealable film such as a polyolefin film (e.g., polyethylene or polypropylene) or to a polyester film, to produce a material suitable for packaging materials.

Decorative packaging may be desired, particularly for packaging used with consumer products, by incorporating printed films into the packaging. These printed films are generally disposed between layers of the laminated packaging material to provide protection and enhanced appearance. This can be achieved by printing the film and metalizing over the print before further conversion.

Two main classes of flexible packaging materials are: 1) mono-web packaging, which includes a mono-web of a coextruded film; and 2) laminated packaging. Laminated packaging is often desired due to the fact that it is advantageous to combine two or more webs in order to obtain the desired properties of the resulting package. Reasons for using laminated packaging constructions include: 1) to contain the graphics between layers in order to provide protection and enhanced appearance; 2) to maintain product freshness by taking advantage of the barrier properties of the individual layers; 3) to combine a heat stable web for printing with a heat sealable web for sealing the package; 4) to provide the desired feel and handling properties to maximize consumer appeal; and 5) to enhance the package strength in order to maintain integrity for filling, shipping, and consumer handling.

Several different technologies are used to bond the layers used in laminated packaging. Two classes of laminating technology are extrusion lamination and adhesive lamination. Extrusion lamination involves melting and depositing a layer of thermal plastic resin such as polyethylene between two webs of packaging materials. Adhesive lamination involves adhering one or more films together using an adhesive layer. The different types of adhesives currently used to laminate flexible packing materials include: 1) one component solvent base; 2) two component solvent base; 3) one component water base; 4) two component water base; 5) two component solventless; 6) one component radiation curable; 7) two component radiation curable and 8) extrusion 100% hot melt adhesives. The adhesive can be used in conjunction with a primer composition to improve adhesion and other properties.

Conventional coating compositions, including primer compositions, fail in condensing humidity tests, water soak, and heat resistance tests. The prior art coatings have disadvantages such as poor water resistance, poor humidity resistance, poor heat resistance, high cost and short pot-life. Also, conventional coatings require the use of hazardous crosslinkers, such as aziridine, polyisocyanates and the like.

All parts and percentages set forth herein are on a weight by weight basis unless specified otherwise.

### SUMMARY OF THE INVENTION

The coating composition comprises two parts. One part (which shall be referred to herein as “Part A”) comprises vinyl acetate ethylene copolymer, acrylic tackifying resin and polyethylene imine. The other part (which shall be referred to herein as “Part B”) comprises a curing agent. The coating composition is preferably water based.

The coating composition is generally applied to film substrates to make laminated packaging materials. Typically, the coating composition acts as a primer. For purposes of this specification and the claims the term “primer” shall refer to coatings or preparations that provide a function that cannot be provided to the substrate or any subsequent adhesive or coating applied to the substrate without the primer coating or composition. In general, the coating compositions described herein are applied to a substrate and form a dry film that enhances adhesion to other bare and metallized films. For example, the coating composition increases the adhesion of adhesives used in making packaging material, including increased adhesion to metallized layers to film, after water soak, heat soak, and/or condensing humidity compared to conventional coating compositions. The coating composition, when applied to a substrate, also enhances metallization and the ability of metal to adhere to the substrate when deposited in a metallization procedure.

### DESCRIPTION OF THE DRAWINGS

FIG. 1 is a cross section of a laminated flexible packaging sheet material comprising a first substrate having a layer of the coating composition in accordance with an embodiment of the invention.

FIG. 2 is a cross section of the laminated flexible packaging sheet material of FIG. 1, further comprising a metal coating on a coated surface.

FIG. 3 is a cross section of a laminated structure comprising the laminated flexible packaging sheet material of FIG. 1 and at least one second substrate.

FIG. 4 is a cross section of a laminated structure comprising the laminated flexible packaging sheet material of FIG. 2 and at least one second substrate.

FIG. 5 is a cross section of a coated material in accordance with an embodiment of the invention comprising a base substrate having a cured layer of the coating composition and an adhesive layer.

FIG. 6 is a cross section of a metallized coated material in accordance with an embodiment of the invention which may be self wound for later use comprising base substrate having a layer of the cured coating composition, a layer of metal material and an adhesive layer.

FIG. 7 illustrates an in-line lamination process.

FIGS. 8A, 8B and 8C illustrate an off-line lamination process.

### DETAILED DESCRIPTION OF THE INVENTION

Part A comprises a vinyl acetate ethylene copolymer, acrylic tackifying resin and polyethylene imine. A typical formulation, Part A is comprised of about 0.1% to about 25%, preferably about 0.1% to about 10%, of polyethylene imine, about 0.1% to about 15%, preferably about 0.1% to about 5% of acrylic tackifying resin and about 30% to about 90%, preferably about 50% to about 80%, of a vinyl acetate ethylene copolymer. Part A also comprises water, typically deionized water, in amounts of about 5% to about 50%, preferably in the range of about 20% to about 35%. Also, Part A optionally includes additives and other materials, such as solvents, ultraviolet (UV) fluorescing agents,antimicrobial compounds, defoaming agents, wetting agents, waxes, silica and combinations thereof, each in small amounts such as up to about 1.5%, including from about 0.1% to about 1.5%. Persons of ordinary skill in these arts, after reading this disclosure, will appreciate that all ranges and values for the components of Part A within the explicitly stated ranges above are contemplated.

Useful vinyl acetate ethylene copolymers include vinyl acetate ethylene copolymer dispersions such as VINNAPAS® 920 and VINNAPAS® 426 both available from Wacker Chemie AG, Munich, Germany and ELVACE® 604 available from Forbo Adhesives LLC, Research Triangle Park, N.C., U.S.A. The vinyl acetate ethylene copolymer may be carboxylated and may have a glass transition temperature (Tg) range from about −30° C. to about +10° C.

The acrylic tackifying resin is typically selected from the group consisting of ethylacrylate acrylic acid, styrene acrylic acid, ethylene acrylic acid, ethylene methacrylic acid, styrene methacrylic acid, vinyl toluene acrylic acid, vinyl toluene methacrylic acid, alpha methyl styrene acrylic acid, alpha methyl styrene methacrylic acid, indene acrylic acid, indene methacrylic acid and combinations thereof. Particularly useful acrylic tackifying agents include ethylacrylate acrylic acid available under the trade name CARBOSET® 515 from The Lubrizol Corporation, Wickcliffe, Ohio, U.S.A., styrene acrylic acid, such as medium molecular weight styrene acrylic acid available under the trade name SOLURYL® 20 from Hanwah Chemical, Seoul, South Korea, low molecular weight styrene acrylic acid available under the trade name INDUREZ® SR 30 from Indulor Chemie GmbH, Ankum, Germany, and ethylene acrylic acid available under the trade name MICHEMPRIME® 4990 from Michelmen Inc., Cincinnati, Ohio, U.S.A.

The polyethylene imine useful in the invention has the typical structure

(CH₂CH₂NH)ₙ

where n is from about 10 to about 50, preferably about 15 to about 35. Preferably, the molecular weight (Mw) is about 1,000 to about 1,500, typically about 1,300. LUPASOL® G20 WF polyethylene imine from BASF, Parsippany, N.J., U.S.A. may be used.

Part B comprises an epoxy curing agent, i.e. an epoxy material. For purposes of this specification, an epoxy material shall be understood to be an epoxide, an organic compound containing a reactive group resulting from the union of an oxygen atom with two other atoms that are joined in some other way. Typically the epoxy material is selected from the group consisting of epoxidized sorbitol, epoxidized soybean oil, epoxidized castor oil, epoxidized novalac, epoxidized linseed oil, epoxidized meta-xylenediamine, epoxidized Bisphenol A, epoxidized menhaden oil, epoxidized styrene, epoxidized Bisphenol F, epoxidized vegetable oil, epoxidized natural rubber, epoxidized diols, epoxidized vernonia oil, epoxidized polyisoprene, epoxidized polybutenes, epoxidized hemp oil, epoxidized polyester, epoxidized polybutadiene, epoxidized tallow, epoxidized cyclopentadiene, epoxidized esters, epoxidized phenolics, epoxidized isobornene, epoxidized limonene, epoxidized pinene, epoxidized terpenes, epoxidized rosin, epoxidized rosin ester, epoxidized abitol, epoxidized polybutadiene acrylonitrile, epoxidized hydrogenated polybutadiene, epoxidized ethylene propylene copolymer and combinations thereof. The preferred epoxies are those selected from the group consisting of epoxidized sorbitol, epoxidized meta-xylenediamine, epoxidized bisphenol A, epoxidized bisphenol F, epoxidized limonene, epoxidized pinene, epoxidized terpenes and combinations thereof. Typically Part B is comprised of 100% of the epoxy material, however, Part B may also comprise additives, fillers and/or other materials with the epoxy material.

Part A and Part B are combined during application at ratios of Part A:Part B of about 99.9:0.1 to about 90:10, preferably from about 99:1 to about 90:10. Persons of ordinary skill in these arts, after reading this disclosure, will appreciate that all ranges and values within these explicitly stated ranges are contemplated. When Part A is combined with Part B during application, the epoxy curing agent cross links the Part A components, particularly, the vinyl acetate ethylene polymer and polyethylene imine to yield a dry film that has the combination of excellent adhesion to a variety of bare and metallized plastic films, excellent water resistance, excellent heat resistance, and excellent resistance to condensing humidity.

The coating composition is applied to one or more substrates to make a laminated structure, such as film for laminated packaging or a label construction. FIGS. 1-6 illustrate typical applications of the coating composition as primer for substrates.

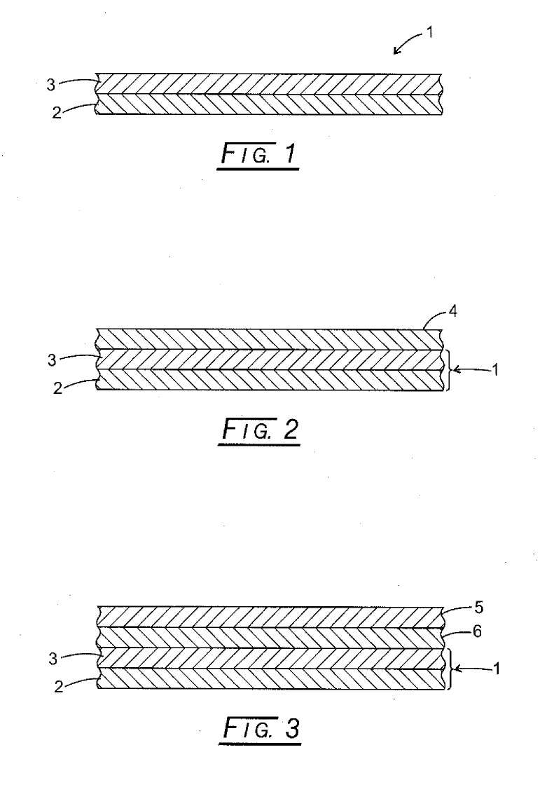

FIG. 1 illustrates coated material, such as flexible packaging sheet material, 1 comprising a first substrate 2 having a layer of the cured coating composition 3, as described herein, on one surface of the first substrate 2. In a further embodiment, as shown in FIG. 2, the coated material 1 may optionally be metallized, such as in a vacuum metalizer, by having a layer of metal material 4 deposited on the layer of the cured coating composition 3. It should be further understood that coating material having layers of cured coating composition on both sides of the first substrate is within the scope of the invention.

The coated material 1 may be used with one of more additional substrates and adhesive, such as a pressure sensitive adhesive (“PSA”) or a heat seal adhesive, to make flexible laminated materials, such as laminated flexible packaging material or label constructions. As shown in FIG. 3, the flexible laminated material comprises the coated material 1 and at least one second substrate 5, such as a layer of flexible material (the over laminate layer), laminated to the first substrate 2 by an adhesive layer 6 in contact with the layer of the cured coating composition 3. In FIG. 3, the adhesive layer 6 may be applied to a surface of the second substrate 5 and then the first substrate 2 and second substrate 5 are laminated together or the adhesive layer 6 may be applied over the layer of the cured coating composition 3 and the first and second substrates (2 and 5) are laminated together. One skilled in the art would appreciate that flexible laminated material comprising the coating composition may have additional substrates, adhesive layers and layers of coating composition.

FIG. 4 illustrates an embodiment wherein the basic construction of FIG. 3 comprises a metallized layer. As shown in FIG. 4, the flexible laminated material comprises the coated material 1 and at least one second substrate 5, such as a layer of flexible packaging material (the over laminate layer), laminated to the layer of metal material 4 by an adhesive layer 6 and in contact with the layer of the cured coating composition 3. In FIG. 4, the adhesive layer 6 may be applied to a surface of the layer of metal material 4 and then the first substrate 2 and layer of metal material 4 are laminated together or the adhesive layer 6 may be applied over the layer of metal material 4 and the layer of metal material 4 and second substrate 5 are laminated together.

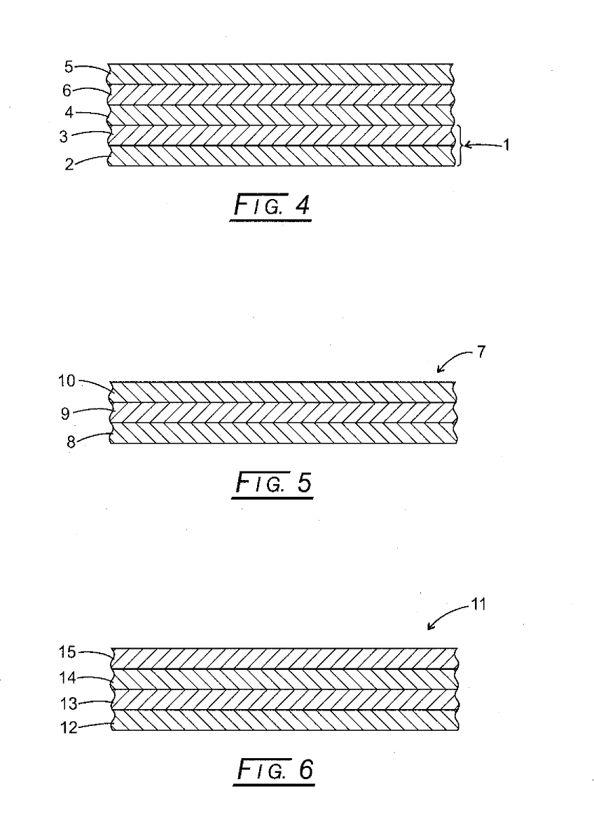

FIG. 5 illustrates an embodiment of the invention wherein a coated material 7 comprising base substrate 8 having a layer of the cured coating composition 9 adjacent to a surface of the base substrate 8 and an adhesive layer 10 on the layer of the cured coating composition 8. The coated material 7 may then be self wound for later use. FIG. 6 illustrates an embodiment of a metallized coated film 11 which may be self wound for later use. The metallized coated film comprises a base substrate 12 having a layer of the cured coating composition 13 adjacent to a surface of the base substrate 12. A layer of metal material 14 is deposited on the cured primer composition 13 and an adhesive layer 15 is juxtaposed to the layer of metal material 14.

Any substrates useful in making laminated materials, such as laminated film packaging and label construction, may be used with the coating composition described herein. Typically, the substrate is selected from the group consisting paper, aluminum foil, metallized films, coated films, printed films, co-extruded films, polyester films, polyolefin based films, white polyolefin based films, polyamide based films, copolymer films, films containing various polymer blends and combinations thereof. The substrate is generally a flexible material, such as flexible material having a thickness of about 7.0 microns to about 25 mils, including all thicknesses within this range.

The formation of laminated flexible materials is well-known and therefore will not be discussed in detail herein. The novel laminated flexible materials made with the coating composition described herein can be easily produced using conventional techniques. The coating material is generally used in conjunction with an adhesive to make the laminated structure.

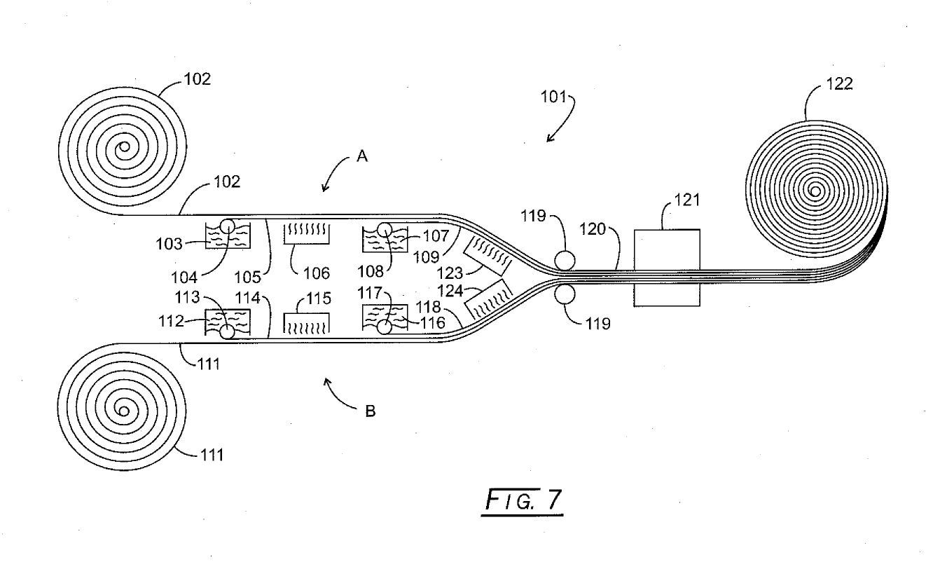

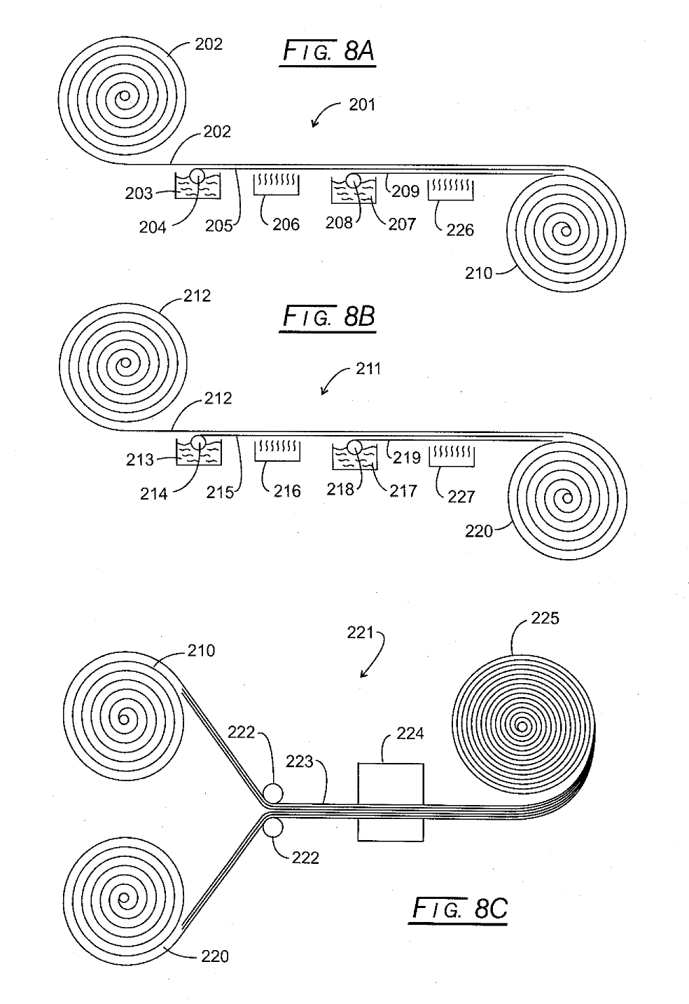

Generally the formulation may be applied as a coating in making laminated films comprising at least a base film and a second film using in line processes as shown in FIG. 7 or off line processes as shown in FIG. 8. In such in-line processes 101, shown in FIG. 7, in a first line A, a first layer of flexible material, 102, is unwound. Next the coating composition 103 is applied to the first layer 102 using a coating application roller 104 to form a coating layer 105. The first layer 102 with coating layer 105 is dried 106 using methods well understood in the art and then an adhesive 107, such as a solventless laminating adhesive, or heat seal adhesive is applied to the dried coating layer 105 using a coating application roller 108 to form an adhesive layer 109, which is dried 123 using methods well known in the art. In a second line B, a second layer of flexible material 111 is unwound. Next the coating composition 112 is applied to the second layer 111 using a coating application roller 113 to form a coating layer 114. The second layer 111 with coating layer 114 is dried 115 using methods well understood in the art and then an adhesive 116, such as a solventless laminating adhesive, or heat seal adhesive is applied to the dried coating layer 114 using a coating application roller 117 to form an adhesive layer 118, which is dried 124 using methods well known in the art. The first layer of flexible material with coating and adhesive and second layer of flexible material with coating and adhesive are then run through nip rollers 119, that may be heated, with the adhesive layers juxtaposed to form a sheet of flexible material 120. This sheet 120 may then be subjected to post-web formation processing 121 which usually includes trimming, slitting and/or sheeting and the finished product may be rewound to form a roll 122 of laminated material. In an embodiment of the invention, either the first layer of flexible material 102 or second layer of flexible material 111 is metallized.

An off-line process is shown in FIGS. 8A, 8B and 8C. FIG. 8A shows a first line 201, in which a first layer of flexible material, 202, is unwound. Next the coating composition 203 is applied to the first layer 202 using a coating application roller 204 to form a coating layer 205. The first layer 202 with coating layer 205 is dried 206 using methods well understood in the art and then an adhesive 207, such as a solvent based heat seal adhesive, is applied to the dried coating layer 205 using a coating application roller 208 to form an adhesive layer 209, which is dried 226 using methods well known in the art. Then the first layer of flexible material with coating and adhesive is wound 210. In a separate second line 211, as shown in FIG. 8B, a second layer of flexible material 212 is unwound. Next the coating composition 213 is applied to the second layer 212 using a coating application roller 214 to form a coating layer 215. The second layer 212 with coating layer 214 is dried 216 using methods well understood in the art and then an adhesive 217, such as a solvent based heat seal adhesive, is applied to the dried coating layer 214 using a coating application roller 218 to form an adhesive layer 219, which is dried 227 using methods well known in the art. Then the second layer of flexible material with coating and adhesive is wound 220. In a laminating line 221, as shown in FIG. 8C, the first layer of flexible material with coating and adhesive 210 and second layer of flexible material with coating and adhesive 220 are each unwound and then run through nip rollers 222, which may be heated, with the adhesive layers juxtaposed to form a sheet flexible material 223. This sheet 223 may then be subjected to post-web formation processing 224 which usually includes trimming, slitting and/or sheeting and the finished product may be rewound to form a roll 225 of laminated material. In an embodiment of the invention, either the first layer of flexible material 202 or second layer of flexible material 212 is metallized.

Specific application techniques, using printed or unprinted films, are generally described below.

In line film lamination wherein the coating composition is applied to a base film substrate and dried. Then adhesive is applied to the coated side of the substrate and the adhesive is dried if the adhesive is not 100% solids. Then the over laminate film is laminated. If the adhesive is UV or EB curable, the laminated structure will be exposed to UV or EB radiation to cure the adhesive.

Off line film lamination wherein the coating composition is applied to a base film substrate, dried and self wound. Then in a second coating operation, adhesive is applied to the coated side of the substrate and the adhesive is dried if the adhesive is not 100% solids. Then the over laminate film is laminated. If the adhesive is UV or EB curable, the laminated structure will be exposed to UV or EB radiation to cure the adhesive.

In line film lamination wherein the coating composition is applied to the base film substrate and dried. Then the adhesive is applied to the over laminate film and dried, if the adhesive is not 100% solids. Then the over laminate film is laminated to the coated base film substrate. If the adhesive is UV or EB curable, the laminated structure will be exposed to UV or EB radiation to cure the adhesive.

Off line film lamination wherein the coating composition is applied to the base film substrate, dried and self wound. Then in a second coating step the adhesive is applied to the over laminate film and dried, if the adhesive is not 100% solids. Then the over laminate film is laminated to the coated base film substrate. If the adhesive is UV or EB curable, the laminated structure will be exposed to UV or EB radiation to cure the adhesive.

In line adhesive primer/tie coat wherein the coating composition is applied to a base film substrate and dried. Then a PSA is applied to the layer of dried coating composition and the PSA is dried, if the PSA is not 100% solids. If the PSA is UV or EB curable, the PSA will be cured by exposure to UV or EB radiation. Next the release liner is applied on the surface of the PSA layer of coating composition and base film.

Off line adhesive primer/tie coat wherein the coating composition is applied to a base film substrate and dried. Then a PSA is applied to the layer of dried coating composition and the PSA is dried if the PSA is not 100% solids. If the adhesive is UV or EB curable, the PSA will be cured by exposure to UV or EB radiation. Next the release liner is applied on the surface of the PSA layer of coating composition and base film.

In line adhesive primer/tie coat wherein the coating composition is applied to the base film substrate and dried. Then a PSA is applied to a release liner and dried, if the PSA is not 100% solids. If the PSA is UV or EB curable, the PSA will be cured by exposure to UV or EB radiation. Next the release liner is applied on the surface of the PSA layer of coating composition and base film.

Off line adhesive primer/tie coat wherein the coating composition is applied to the base film substrate, dried and self wound. Then in a second coating step, a PSA is applied to a release liner and dried, if the PSA is not 100% solids. If the PSA is UV or EB curable, the PSA will be cured by exposure to UV or EB radiation. Next the PSA coated release liner is applied on the surface of the coating composition and base film.

In line adhesive primer/tie coat wherein the coating composition is applied to a base film substrate and dried. Then a heat seal adhesive is applied to the layer of dried coating composition and the heat seal adhesive is dried, if the heat seal adhesive is not 100% solids. If the heat seal adhesive is UV or EB curable, the heat seal adhesive will be cured by exposure to UV or EB radiation. The base film substrate comprising the layers of coating composition and heat seal adhesive is then self wound.

Off line adhesive primer/tie coat wherein the coating composition is applied to a base film substrate and dried and then the coated base film substrate is self wound. Also, a heat seal adhesive may be applied to the layer of dried coating composition and the heat seal adhesive is dried, if the heat seal adhesive is not 100% solids. If the heat seal adhesive is UV or EB curable, the heat seal adhesive will be cured by exposure to UV or EB radiation. The base film substrate comprising the layers of coating composition and heat seal adhesive is then self wound.

Off line metallization wherein the coating composition is applied to a base film substrate, dried and self wound. Then the coated base film substrate is metallized, such as by being placed in a vacuum metalizer.

### EXAMPLES

### Example 1

A coated substrate was made by applying a coating composition in accordance with the invention comprising NWC 23618 (Part A) from Ashland Inc., Dublin, Ohio, U.S.A. (“Ashland”), with a epoxidized sorbitol curing agent (Part B) to untreated biaxially oriented polypropylene (“BOPP”). The coating composition having 97% Part A and 3% Part B was applied on an aged sample of BOPP film that was not chemically, flame, corona, or plasma treated with a #3 Wire wound rod, and dried at 60° C. for 5 minutes to achieve a dry film coating weight of 1.5 dry grams per square meter (“gun”) to 2.5 dry gsm Immediately after the primer was applied and dried, FLEXCRYL® AF 2027, FLEXCRYL® SP 38 Water or FLEXCRYL® AF 2054 Water base emulsion PSA adhesives, all available from Ashland, were applied directly on release liner with a #28 Wire wound rod, and dried at 60° C. for 5 minutes to achieve a dry film coating weight of 18 dry gsm to 25 dry gsm. The adhesive coated release liner was laminated to the primer coated BOPP using 2 passes of the 4 pound roller. Then the laminated films were allowed to equilibrate 24 hours at 25° C. 50% relative humidity (“RH”).

After 24 hours the release liner was removed and the PSA was laminated to clean stainless steel panels using 4 passes of a 4 pound roller. Then the laminated panels were placed in an environmental chamber at 40° C. and 54° C. using 100% RH humidity for 20 minutes. Immediately after the 20 minutes 100% RH exposure, the primed and adhesive coated BOPP was pulled away form the steel applying PSTC-1, 180 Degree peel test standard which is incorporated herein in its entirety by reference. Peel values were recorded. The PSA's adhesively failed off the stainless steel with no loss of adhesion of the primer to the BOPP and no loss of adhesion of the PSA off primer and adhesive coatings.

### Example 2

A coated substrate was made by applying a coating composition in accordance with the invention comprising NWC 23618 (Part A) from Ashland, with a epoxidized sorbitol curing agent (Part B) to both BOPP and polyethylene (“PE”). The Part A (97%) and Part B (3%) components were applied to both BOPP and PE, with a #3 Wire wound rod, and dried at 60° C. for 5 minutes to achieve a dry film coating weight of 1.5 dry gsm to 2.5 dry gsm Immediately after the primer was applied and dried, heat seal adhesive (23535E available from Ashland) was applied directly on the primer with a #28 Wire wound rod, and dried at 60° C. for 5 minutes to achieve a dry film coating weight of 18 dry gsm to 25 dry gsm. The primed and adhesive coated films were allowed to equilibrate for 24 hours at 25° C. 50% RH. Then the primed and adhesive coated film was heat sealed through the BOPP or PE at 3.0 to 4.0 seconds, at 150° C. to 160° C. and 60 PSI, to interior automotive grades of PVC substrates. Then the heat sealed samples were allowed to come to room temperature. Then the films were immersed in 25° C. tap water for 24 hours. Samples were removed from the water and the PVC was pulled apart by hand from the heat seal. Neither the coated BOPP substrate nor the coated PE substrate exhibited adhesive failure.

### Example 3

A coated substrate was made by applying a coating composition in accordance with the invention comprising NWC 23618 (Part A) from Ashland, with a epoxidized sorbitol curing agent (Part B) to biaxially oriented polypropylene (“BOPP”) and polyethylene via full size direct gravure coater to achieve a dry film coating weight of 1.5 dry gsm to 2.5 dry gsm.

Aluminum was deposited, by a full size production vacuum metallization coater on the primed surface of the coated BOPP substrate prepared in Example 1. Samples of the metallized BOPP coated substrate was then soaked for 2 hours in an ice and water bath at 0° C. At the end of the 2 hours the coated substrate was subjected failure testing and no failure of the metallized layer occurred.

We claim:

1. A two component composition comprising a Part A comprising vinyl acetate ethylene copolymer, acrylic tackifying resin and polyethylene imine and a Part B comprising an epoxy material.

2. The two component composition of claim 1 wherein the Part A comprises 0.1% to about 25% polyethylene imine, about 0.1% to about 15%, acrylic tackifying resin and about 30% to about 90% vinyl acetate ethylene copolymer.

3. The two component composition of claim 1 wherein the Part A further comprises about 5% to about 50% water.

4. The two component composition of claim 1 wherein the Part A further comprises additives selected from the group consisting of solvents, UV fluorescing agents, antimicrobial compounds, defoaming agents, wetting agents, waxes, silica and combinations thereof.

5. The two component composition of claim 1 wherein the acrylic tackifying resin is selected from the group consisting of ethylacrylate acrylic acid, styrene acrylic acid, ethylene acrylic acid, ethylene methacrylic acid, styrene methacrylic acid, vinyl toluene acrylic acid, vinyl toluene methacrylic acid, alpha methyl styrene acrylic acid, alpha methyl styrene methacrylic acid, indene acrylic acid, indene methacrylic acid and combinations thereof.

6. The two component composition of claim 1 wherein the epoxy material is selected from the group consisting of epoxidized sorbitol, epoxidized soybean oil, epoxidized castor oil, epoxidized novalac, epoxidized linseed oil, epoxidized meta-xylenediamine, epoxidized Bisphenol A, epoxidized menhaden oil, epoxidized styrene, epoxidized Bisphenol F, epoxidized vegetable oil, epoxidized natural rubber, epoxidized diol, epoxidized vernonia oil, epoxidized polyisoprene, epoxidized polybutene, epoxidized hemp oil, epoxidized polyester, epoxidized polybutadiene, epoxidized tallow, epoxidized cyclopentadiene, epoxidized ester, epoxidized phenolic, epoxidized isobornene, epoxidized limonene, epoxidized pinene, epoxidized terpene, epoxidized rosin, epoxidized rosin ester, epoxidized abitol, epoxidized polybutadiene acrylonitrile, epoxidized hydrogenated polybutadiene, epoxidized ethylene propylene copolymer and combinations thereof.

7. A coated substrate comprising a first substrate having at least a first surface and a cured layer of the two part composition of claim 1 on the first surface.

8. The coated substrate of claim 7 wherein the first substrate is a flexible material having a thickness of about 7.0 microns to about 25 mils.

9. The coated substrate of claim 7 wherein the first substrate is selected from the group consisting of paper, aluminum foil, metallized films, coated films, printed films, co-extruded films, polyester films, polyolefin based films, white polyolefin based films, polyamide based films, copolymer films, films comprising polymer blends and combinations thereof.

10. The coated substrate of claim 7 further comprising a layer of adhesive on the cured layer of the two part composition.

11. The coated substrate of claim 7 further comprising a layer of metal on the cured layer of the two part composition.

12. The coated substrate of claim 11 further comprising a layer of adhesive on the layer of metal.

13. A laminated structure comprising the coated substrate of claim 12 and a second substrate wherein the second substrate is adhered to the layer of adhesive.

14. The laminated structure of claim 13 wherein the first substrate or second substrate is selected from the group consisting paper, aluminum foil, metallized films, coated films, printed films, co-extruded films, polyester films, polyolefin based films, white polyolefin based films, polyamide based films, copolymer films, films comprising polymer blends and combinations thereof.

15. A laminated structure comprising the coated substrate of claim 12 and a second substrate wherein the second substrate is adhered to the layer of adhesive.

16. A process for making a coated substrate comprising the steps of providing a) a first substrate having at least a first surface, b) providing the two part composition of claim 1, c) applying the two part composition to the first surface while combining Part A and Part B on the first surface and d) curing the two part composition after application to the first surface.

17. The process of claim 16 wherein the ratio of the Part A to the Part B is about 99.9:0.1 to about 90:10.

18. The process of claim 16 further comprising applying a layer of metal to the two part composition after application to the first surface.

19. A process for making a laminated structure comprising the steps of providing a) a first substrate having at least a first surface, b) providing the two part composition of claim 1, c) applying the two part composition to the first surface while combining Part A and Part B on the first surface to form a primer layer, d) providing a second substrate having at least second substrate first surface, e) providing an adhesive, f) applying the adhesive to either the primer layer or the second substrate first surface to form an adhesive layer, g) adhering the first substrate and second substrate to each other having the primer layer and the adhesive layer in contact.

20. The process of claim 19 wherein the primer layer is cured before adhering the first substrate and second substrate.

21. The process of claim 19 further comprising the step of applying a layer of metal to the primer layer or the adhesive layer.
